(19) United States
(12) Patent Application Publication
(10) Pub. No.: US 2025/0264128 A1
(43) Pub. Date: Aug. 21, 2025

(54) FASTENER RETENTION METHOD AND APPARATUS

(71) Applicant: DEIS Products LLC, Austin, TX (US)

(72) Inventor: Joshua Z. Gahr, Austin, TX (US)

(73) Assignee: DEIS Products LLC, Austin, TX (US)

(21) Appl. No.: 19/052,574

(22) Filed: Feb. 13, 2025

Related U.S. Application Data
(60) Provisional application No. 63/554,163, filed on Feb. 16, 2024.

(51) Int. Cl. F16B 39/10

(52) U.S. Cl. CPC F16B 39/10

(57) ABSTRACT

A fastener retention apparatus with a body having a cavity to receive a fastener. The body having a ring disposed thereon, wherein the ring is configured for rotation on the body such that at least one locking ball transitions between an engagement position and a disengagement position within an orifice on the body for selective rotation of the fastener. A method of retaining a fastener.

### CROSS REFERENCE TO RELATED APPLICATIONS

This application claims priority to U.S. Provisional Patent Application No. 63/554,163 filed on Feb. 16, 2024, titled “Fastener Retention Method and Apparatus.” The entire disclosure of Application No. 63/554,163 is hereby incorporated herein by reference.

### FIELD OF THE INVENTION

This disclosure relates generally to devices for securing fasteners. More particularly, the disclosure relates to a retention device that is capable of securing a fastener on the shank of a pin member for an indefinite period of time.

### BACKGROUND

Mechanical bolts are generally held in place by different types of conventional fasteners (e.g., cotter pins, keys, wires, threaded nuts, etc.). For many applications, the use of conventional fasteners is sufficient. However, some applications require a more secure means of ensuring the fastener will stay put and not become dislodged from the bolt. For example, shackles are devices that are used as connecting links in all manner of rigging systems in many industries, from boats and ships to industrial crane rigging, as they allow different bolt rigging subsets to be connected or disconnected quickly. Some shackles are used in temporary rigging to make lifts while other applications require shackles to remain in service for an extended period. Conventional shackles used for suspending objects require that the nut or fastener remain securely in place for safety reasons as well as operability.

FIG. 1 shows a conventional shackle 10 complete with a threaded pin member 12, customary half-width securing hex nut fastener 14, and a hole 16 for a retaining pin complete with a cotter pin 18 installed. In this type of installation, the shackle 10 is typically secured to slings or other equipment or lifting members, the pin member 12 is installed through each hole in the shackle leg, the nut 14 is screwed onto the pin threads and adequately tightened, and the cotter pin 18 is installed through the hole 16 in the end of the pin. Such shackles 10 are designed and manufactured to safely handle loads from tens of pounds to thousands of tons.

A common issue with shackles and other types of fasteners is the failure of the bolt or pin member to remain securely fastened in place. The sudden failure of fasteners can cause work delays, equipment damage, or worse, human injury or death. This is a particular issue when fasteners are used for extended duration or in high-energy environments where continual motion, loading cycles, or vibration occur, increasing the likelihood of loosening and unexpected pin member separation. For bolt-type pin members, the nut or fastener may not be properly torqued. For round pin or bolt-type pin members that use a cotter key or other retaining clip or wire, the retaining mechanism may be improperly sized (pin too small), improper for the application (diaper pin vs. cotter pin), or the retention component may be reused resulting in a weakened retention system (reused cotter pins). Incorrect material type is also a potential cause of fastener failure. Primary or secondary fastener components (keys, wires, cotter pins, etc.) with substandard material characteristics (hardness, ductility, alloy composition) are susceptible to fatigue, breakage and corrosion.

A need remains for a device that can be used on a variety of pin members that will positively secure a fastener to the member, preventing unintended release of the pin or fastener, and be easily installed or removed without the need for special tools.

### SUMMARY

According to an aspect of the invention, a fastener retention apparatus includes a body having a cavity to receive a fastener. The body having a ring disposed thereon, wherein the ring is configured for rotation on the body such that at least one locking ball transitions between an engagement position and a disengagement position within an orifice on the body for selective rotation of the fastener.

According to another aspect of the invention, a method of retaining a fastener includes disposing a fastener on a body having a cavity to receive the fastener, and selectively rotating the fastener by rotating a ring disposed on the body such that at least one locking ball transitions between an engagement position and a disengagement position within an orifice on the body.

Other aspects of the embodiments described herein will become apparent from the following description and the accompanying drawings, illustrating the principles of the embodiments by way of example only.

### BRIEF DESCRIPTION OF THE DRAWINGS

The following figures form part of the present specification and are included to further demonstrate certain aspects of the present disclosure and should not be used to limit or define the claimed subject matter. The claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 shows a perspective view of a conventional shackle with a customary locking fastener and securing pin.

FIG. 2 shows a perspective view of a fastener retention body according to an example of the present disclosure.

FIG. 3 shows a side view of the fastener retention body of FIG. 2.

FIG. 4 shows a perspective view of a ring section according to an example of the present disclosure.

FIG. 5A shows a plan view of a ring section according to an example of the present disclosure.

FIG. 5B shows a plan view of another ring section according to an example of the present disclosure.

FIG. 6 shows a perspective view of a fastener retaining body and ring assembly according to an example of the present disclosure.

FIG. 7 shows a plan view cross section of a fastener retaining body and ring assembly according to an example of the present disclosure.

FIG. 8 shows another plan view cross section of the fastener retaining body and ring assembly of FIG. 7.

FIG. 9 shows a perspective view of a conventional shackle with a fastener retaining body and ring assembly according to an example of the present disclosure.

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. It will be understood that as used in this description, the term “pin member” encompasses all forms of screws, bolts, locking pins, and other forms of devices having a shank and used to fasten and/or retain items as known in the art. It will also be understood that as used in this description, the term “fastener” encompasses all forms of nut types used to couple to pin members as known in the art.

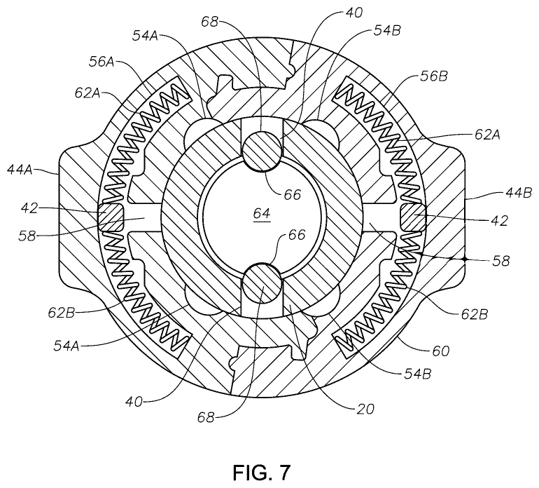

FIG. 2 shows a perspective view of a fastener retention body 20 embodiment of this disclosure. In some embodiments, the body 20 is formed as a one-piece circular structure. A cavity 22 is formed to define one side of the body 20. The illustrated body 20 embodiment shows the cavity 22 formed with sufficient depth and linear walls 24 defining a space to receive and rigidly hold a conventional hex nut fastener (see 70 in FIG. 9). It will be understood by those skilled in the art that other body 20 embodiments may be configured with the cavity 22 formed to receive and hold other types of fasteners (e.g. square nuts). The cavity 22 opening has a smooth planar surface 26. In some embodiments, the body 20 may be configured with one or more protrusions 28 extending outward from the exterior side wall of body near the cavity 22 opening. The protrusion(s) 28 facilitates manipulation and rotation of the body 20 by a user (further described below). The body 20 is also formed with an opening 30 along its central axis. The opening 30 is configured to allow a pin member to pass through a fastener retained in the cavity 22 (see FIGS. 7, 8, 9).

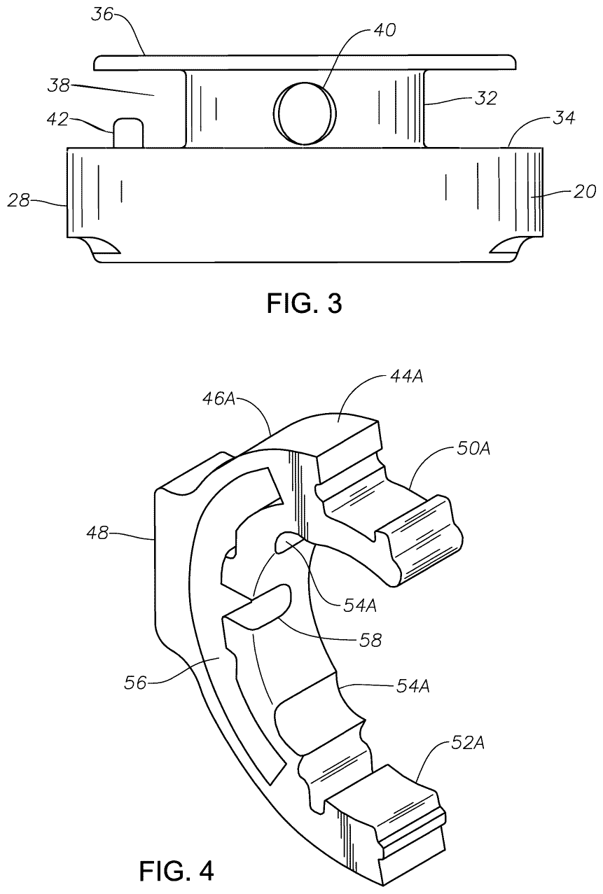

Turning to FIG. 3, a side view of a body 20 embodiment is shown. The body 20 is configured with a raised section 32 extending from the surface 34 opposite the cavity 22. The raised section 32 forms a column with a smaller radius compared to the radius of the walled section defining the cavity 22. The top of the raised section 32 terminates to form a flat annular disc 36 (see FIG. 6). The disc 36 section is formed with a greater diameter compared to the diameter of the raised section 32. In some embodiments, the disc 36 section is formed with a diameter to match the diameter of the cavity 22 section (see FIG. 6). In between the disc 36 and surface 34, an annular gap 38 is formed. The raised section 32 is also configured with an orifice 40 laterally extending through the wall of the column. The body 20 is also configured with a detent 42, in the form of a pin, extending between surface 34 and the inner surface of disc 36 (further described below).

FIG. 4 shows a perspective view of a section 44A forming one-half of a ring (see 60 in FIG. 6). The section 44A is formed as an arch structure with a smooth curved exterior surface 46A. The embodiment shown in FIG. 4 is configured with a raised protrusion 48 extending outward from a section of the exterior surface 46A. The protrusion 48 facilitates manipulation and rotation of the ring 60 by a user (further described below). One end of the arch section 44A is formed with a contoured extension 50A having a recess and/or ridge formation. The other end of the arch section 44A is also formed with a contoured extension 52A having a recess and/or ridge formation. The inner surface of the arch section 44A is configured with one or more semi-circular indentations or voids 54A. A channel 56 is formed along the curved section of the arch section 44A. The channel 56 forms a walled curved section with an opening on one side of the section 44A. A slit 58 is formed along the inner wall of the arch section 44A near the center of the channel 56.

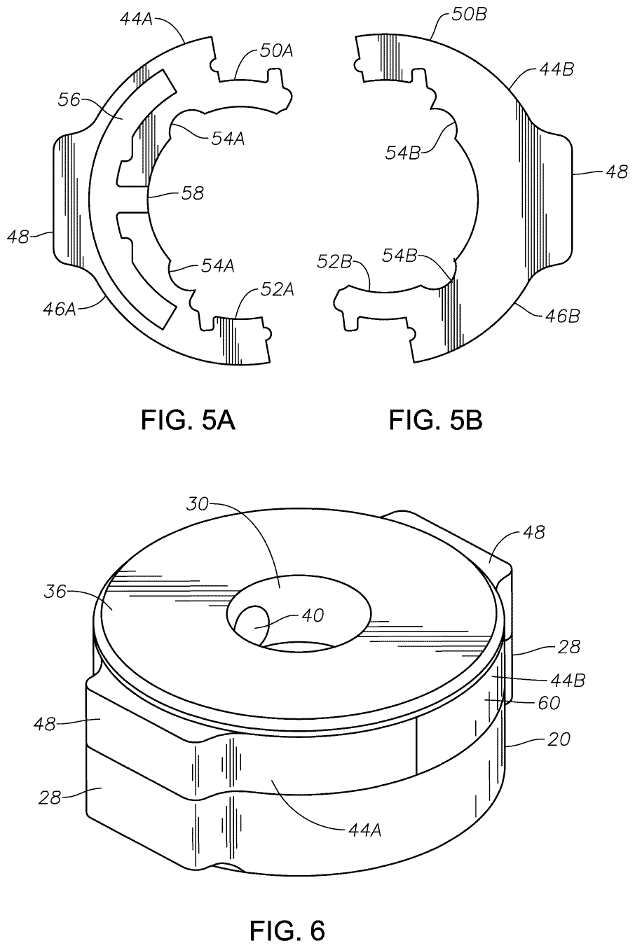

FIG. 5A shows a plan view of the ring section 44A of FIG. 4. This view more clearly shows the geometry of the contoured extensions 50A, 52A. FIG. 5B shows a plan view of another section 44B forming one-half of a ring (see 60 in FIG. 6). The section 44B is also formed as an arch structure with a smooth curved exterior surface 46B. The embodiment shown in FIG. 5B is also configured with a raised protrusion 48 extending outward from a section of the exterior surface 46B. The inner surface of the arch section 44B is also configured with one or more semi-circular indentations or voids 54B. One end of the arch section 44B is formed with a contoured extension 50B having a recess and/or ridge formation configured to match and couple with the contoured extension 50A of section 44A. The other end of the arch section 44B is also formed with a contoured extension 52B having a recess and/or ridge formation configured to match and couple with the contoured extension 52A of section 44A. As can be seen in FIGS. 5A and 5B, when the two sections 44A, 44B are joined together such that the contoured extensions 50A, 50B, 52A, 52B respectively engage one another, a ring is formed (see 60 in FIG. 6).

FIG. 6 shows a perspective view of a retainer body 20 configured with a ring 60 embodiment of this disclosure. The ring 60 is formed by disposing the two sections 44A, 44B in the annular gap 38 of the body 20 around the raised section 32 (see FIG. 3). The two sections 44A, 44B are joined together such that the contoured extensions 50A, 50B, 52A, 52B respectively engage one another to form the ring 60. As shown in FIG. 6, embodiments can be implemented with the body 20 and the ring 60 each respectively having a pair of protrusions 28, 48 formed on the exterior surfaces such that the protrusions are in alignment with one another when the ring 60 is disposed on the body 20.

FIG. 7 shows a plan view cross section of a body 20 configured with a ring 60 embodiment of this disclosure. Although embodiments may be implemented with a ring 60 having only one arch section 44A with a curved channel 56 (see FIG. 5A), the embodiment of FIG. 7 is configured with each arch section 44A, 44B having a respective channel 56A, 56B formed therein. In this embodiment, the two sections 44A, 44B mirror each other in terms of components and functionality. Each section 44A, 44B respectively includes a pair of springs 62A, 62B disposed in each channel 56A, 56B. Any conventional spring 62A, 62B means may be used to implement embodiments of this disclosure. Each set of springs 62A, 62B is separated from one another by a pair of detents 42 disposed on the body 20 surface 34 (see FIG. 3). When joining the arch sections 44A, 44B to dispose the ring 60 on the body, the slit 58 (see FIG. 4) formed along the inner wall of each section permits the respective detent 42 to pass through so that the sections can be slid into place in the annular gap 38. FIG. 7 shows the contoured extensions 50A, 50B, 52A, 52B respectively coupled with one another to form the ring 60. FIG. 7 also shows the cross section of a pin member 64 disposed to pass through the central opening 30 formed on the body 20 (see FIG. 9). The pin member 64 is configured with a pair of indentations or voids 66 to receive and seat a pair of locking balls 68 disposed in the orifices 40 in the raised section 32 of the body 20.

FIG. 7 shows an embodiment wherein the locking balls 68 are in the engagement position within the orifices 40 in the raised section 32 of the body 20. In this position, the balls 68 are recessed in the orifices 40 such that they seat within the voids 66 in the pin member 64. With the balls 68 seated within the voids 66, the pin member 64 is physically locked with the raised section 32 of the body 20. The body 20, in turn, holds and retains the fastener (see 70 in FIG. 9). Thus, the fastener 70 is restrained from rotation with respect to the pin member 64. In this manner, the fastener 70 is securely locked in place on the pin member 64. With bolt-type pin members 64 the fastener 70 may consist of a threaded nut to engage with the threads on the shank of the bolt.

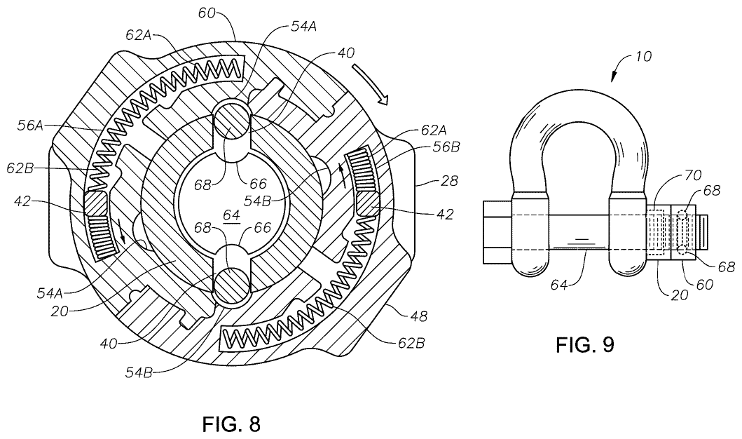

Turning to FIG. 8, operation of the embodiment of FIG. 7 to transition from the engagement position to a disengagement position is now described. By turning the ring 60 to the right (as shown by the arrow) with respect to the body 20, the voids 54A, 54B in the ring (see FIGS. 4, 5A, 5B) are brought into alignment with the orifices 40 on the body 20. Once in alignment, the voids 54A, 54B on the ring provide sufficient room for the locking balls 68 to ride out of the voids 66 on the pin member 64 to reside seated against the ring voids 54A, 54B. With the balls 68 seated within the ring 60 voids 54A, 54B, the body 20 is now physically locked with the ring 60, while the pin member 64 is unlocked from the body 20. In this position, the fastener 70 in the body 20 cavity 22 is free to rotate with respect to the pin member 64, and vice-versa. For standard right-handed threaded pin members 64, turning the ring 60 to the right as depicted by the arrow would tighten a threaded fastener 70 onto a threaded pin member coming out of the page as shown in FIG. 8. Embodiments respectively configured with body 20 and ring 60 protrusions 28, 48 facilitate manual rotation of the body and/or ring by a user.

FIG. 8 also shows the interaction of the springs 62A, 62B in the ring sections 44A, 44B during transition from the engagement position to the disengagement position. As the ring 60 is turned to the right as reflected by the arrow, springs 62A are compressed against the respective detent 42 in each ring section 44A, 44B, while springs 62B are in a neutral mode (i.e. uncompressed). In the compressed state, springs 62A provide a biasing force (depicted by small arrows in FIG. 8) against the rotation of the ring 60, to the right in this case. As discussed above, a user would typically turn the ring 60 to the right to tighten a right-handed threaded fastener 70 on a pin member 64.

Upon release of the turning force on the ring 60, the force of the compressed springs 62A against the respective detent 42 and channel 56A, 56B wall will automatically return the ring 60 to the left. Upon return of the ring 60 to the left, the locking balls 68 rotate back into the orifices 40 in the raised section 32 of the body 20, returning to the engagement position as shown in FIG. 7. In this manner, the default state of the fastener 70 is to always remains securely retained from rotation with respect to the pin member 64 until the ring 60 is selectively rotated as desired.

It will be understood that rotation of the ring 60 in the opposite direction to that depicted in FIG. 8 (i.e., rotation toward the left of the image) will place springs 62B in compression against the respective detent 42 in each ring section 44A, 44B, while springs 62A will remain in a neutral mode (i.e. uncompressed). In this case, the compressed springs 62B will provide a biasing force against rotation of the ring 60, to the left in such case. As discussed above, a user would typically turn the ring 60 to the left to loosen a right-handed threaded fastener 70 on a pin member 64. Transition between the engagement position and disengagement position will be the same as previously described in this case as well. Upon release of the turning force on the ring 60, the force of the compressed springs 62B against the respective detent 42 and channel 56A, 56B wall will automatically return the ring 60 to the right. Upon return of the ring 60 to the right, the locking balls 68 rotate back into the orifices 40 in the raised section 32 of the body 20, returning to the engagement position as shown in FIG. 7. In this manner, the fastener 70 always remains securely retained from rotation with respect to the pin member 64 until the ring 60 is selectively rotated as desired.

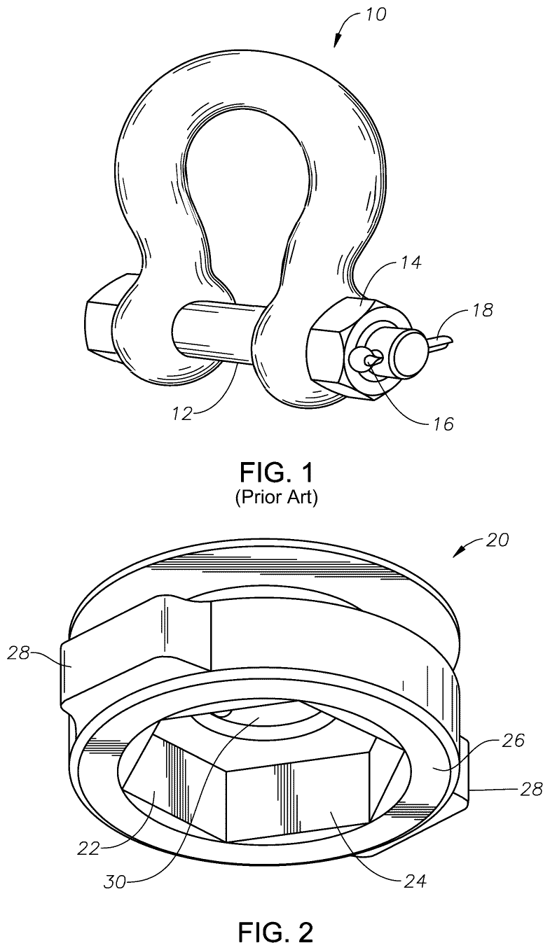

FIG. 9 shows the shackle 10 of FIG. 1 with a pin member 64 and fastener 70 secured in place by a retaining body 20 according to the embodiments of this disclosure. The pin member 64 may be a conventional metallic threaded bolt and the fastener 70 a conventional metallic threaded nut. As shown in FIG. 9, the fastener 70 has been threaded into a locking position on the bolt 64 shaft by rotating the ring 60 and body 20 as described herein. Upon engagement of the fastener 70 to the pin member 64 to the desired tightness or torque, the ring 60 is positioned such that the locking balls 68 are in the engagement position and the fastener 70 is securely retained in place until selectively actuated as desired. The retaining body 20 may be actuated to remove and replace the fastener 70 on the pin member 64 as often as desired, with the body providing consistent, secure, and reliable retention of the fastener in every instance.

It will be appreciated by those skilled in the art that embodiments of this disclosure can be made completely with non-metallic components. Conventional plastics (e.g., synthetics, composites, etc.) can be used to produce the components for embodiments of this disclosure, including non-metallic springs and locking balls. Such embodiments not only reduce weight, they are also more durable as they are corrosion resistant and can be used in high moisture environments without need for special coatings or enclosures. Embodiments may also be produced using binder jetting additive manufacturing (3D printing). Embodiments of this disclosure can also be made completely with metallic components. For example, ring 60 components can be produced with hinged arch sections and coupling clasps as known in the art. Yet other embodiments may be produced with a mixture of metallic and non-metallic components. For example, embodiments may be implemented with composite bodies 20 and rings 60 in combination with metallic springs 62A, 62B and locking balls 68. In light of the example embodiments described and illustrated herein, it will be recognized that numerous modifications could be applied to derive alternative embodiments of the present invention. Embodiments of this disclosure may be implemented for use with fasteners and/or pin members of different dimensions, shapes, and sizes as known in the art. What is claimed as the invention, therefore, are all implementations that come within the scope of the following claims.

What is claimed is:

1. A fastener retention apparatus comprising:
a body having a cavity to receive a fastener;
the body having a ring disposed thereon,
wherein the ring is configured for rotation on the body such that at least one locking ball transitions between an engagement position and a disengagement position within an orifice on the body for selective rotation of the fastener.

2. The fastener retention apparatus of claim 1 wherein the ring is configured with at least one spring to provide a biasing force against the rotation of the ring on the body.

3. The fastener retention apparatus of claim 1 wherein the body is configured with an opening to receive a pin member configured to pass through the fastener on the body.

4. The fastener retention apparatus of claim 3 wherein the pin member is configured with at least one void formed thereon to receive the at least one locking ball.

5. The fastener retention apparatus of claim 4 wherein the pin member is configured with threads to engage with the fastener.

6. The fastener retention apparatus of claim 1 wherein the body and/or the ring are each formed of a non-metallic material.

7. The fastener retention apparatus of claim 1 wherein the ring is configured with a plurality of springs to provide a biasing force against the rotation of the ring on the body and a plurality of locking balls configured for transition between an engagement position and a disengagement position within orifices on the body.

8. The fastener retention apparatus of claim 1 wherein the ring is formed of multiple pieces configured to couple to one another.

9. The fastener retention apparatus of claim 1 wherein the ring is configured with at least one protrusion formed on an external surface thereof.

10. The fastener retention apparatus of claim 2 wherein the body is configured with at least one detent to provide a resistance to the at least one spring.

11. The fastener retention apparatus of claim 1 wherein the cavity is configured to receive a fastener consisting of a nut with internal threads.

12. The fastener retention apparatus of claim 11 wherein the body is configured with an opening to receive a pin member consisting of a bolt configured to engage the nut.

13. The fastener retention apparatus of claim 12 wherein the body is configured to prevent rotation of the nut relative to the bolt when the at least one locking ball is in the engagement position.

14. The fastener retention apparatus of claim 1 wherein the ring is configured with at least one void on an inner surface thereof to receive the at least on locking ball.

15. The fastener retention apparatus of claim 1 wherein the ring is configured with a first spring to provide a biasing force against rotation of the ring in a first direction, and a second spring to provide a biasing force against rotation of the ring in a second direction.

16. A method of retaining a fastener, comprising:
disposing a fastener on a body having a cavity to receive the fastener; and
selectively rotating the fastener by rotating a ring disposed on the body such that at least one locking ball transitions between an engagement position and a disengagement position within an orifice on the body.

17. The method of claim 16 wherein the body and/or the ring are each formed of a non-metallic material.

18. The method of claim 16 wherein the ring is configured with at least one spring to provide a biasing force against the rotation of the ring on the body.

19. The method of claim 16 wherein the body is configured with an opening to permit a pin member to pass through the fastener on the body.

20. The method of claim 19 further comprising disposing the body on a pin member configured with at least one void formed thereon to receive the at least one locking ball.
